(19) United States
(12) Patent Application Publication
(10) Pub. No.: US 2008/0011119 A1
(43) Pub. Date: Jan. 17, 2008

(54) Self-lubricating cam/rail follower

(76) Inventor: Georg Bartosch, Demarest, NJ (US)

Correspondence Address: FAY KAPLUN & MARCIN, LLP, 15O BROADWAY, SUITE 702, NEW YORK, NY, 10038, US

(21) Appl. No.: 11/487,638

(22) Filed: Jul. 17, 2006

(51) Int. Cl. F16H 53/00; F16H 53/06

(52) U.S. Cl. 74/567; 74/569

(57) ABSTRACT

A cam or rail follower having a shaft, a rotational inner portion rotating about the shaft, and an outer racer rotating about the shaft, the outer racer being constructed from a self-lubricating material. A system having a cam follower including a shaft and an outer racer, the outer racer being constructed from a self-lubricating material and a cam, the outer racer of the cam follower being in contact with the cam, the contact causing the outer racer to rotate about the shaft of the cam follower, the self lubricating material being softer than a material used to construct the cam.

### BACKGROUND

Cam followers are subject to wear and failure as a result of repeated contact with a cam. A conventional camming arrangement includes a metal cam and a metal cam follower with one or more contact surfaces. As the cam follower contacts the cam, the metal of the cam follower, as well as the metal of the cam become worn and both the cam follower and the cam need to be replaced. The replacement of the cam is very costly and requires a prolonged down time.

In addition, metal cams and cam followers require lubrication such as grease, oil, or other lubricating substance, i.e., lubrication on the cam to prolong its life and internal lubrication of the cam follower. In clean applications (e.g., food processing, pharmaceutical processing, etc), this lubrication can damage, corrupt and/or contaminate the material being processed (e.g., food, medicine, packaging, etc.) or other components or machines in the process. Thus, the maintenance, replacement and repair of metal cam followers requires a substantial amount of time because the lubrication material needs to be properly applied, and even then, this does not completely solve the problem of excess lubrication causing problems with the process.

Over-greasing of the cam follower is also a common occurrence. When the inside of the cam follower is packed with too much grease, the cam follower has a very high resistance to rolling and tends to slide on the metal surface of the cam. This causes excessive cam wear as well as the development of a flat surface on the cam follower. Cam followers that develop a flat surface will not turn and have to be replaced.

In addition, over time, the lubrication decreases and a contact surface of the cam begins to rub directly against a contact surface of the cam follower. This may result in noise (e.g., squeaking), decreased performance (e.g., slower operating speed, higher operating temperature), or even complete failure. Some machines have a central lubrication system. However, these systems have a history of clogging when the lubricant is too viscous. Thus, metal cams and cam followers require substantial maintenance to prevent these undesirable effects. This maintenance is often a difficult and/or time-consuming procedure involving downtime, removal and replacement of the cam follower.

### SUMMARY OF THE INVENTION

A cam or rail follower having a shaft, a rotational inner portion rotating about the shaft, and an outer racer rotating about the shaft, the outer racer being constructed from a self-lubricating material.

A system having a cam follower including a shaft and an outer racer, the outer racer being constructed from a self-lubricating material and a cam, the outer racer of the cam follower being in contact with the cam, the contact causing the outer racer to rotate about the shaft of the cam follower, the self lubricating material being softer than a material used to construct the cam.

A cam follower having a shaft, at least one roller bearing rotatably coupled to the shaft and an outer racer coupled to the at least one roller bearing and being rotatable about the shaft, an outer surface of the outer racer being constructed from a self-lubricating material.

A yoke assembly having a rotational inner portion for rotating about a shaft and an outer racer coupled to the rotational inner portion, the outer racer being constructed from a self-lubricating material.

### BRIEF DESCRIPTION OF THE DRAWINGS

FIG. 1-A shows an exemplary embodiment of a camming arrangement in a neutral position according to the present invention.

FIG. 1B shows an exemplary embodiment of the camming arrangment of FIG. 1-A in an engaged position according to the present invention.

FIG. 2 shows an exemplary embodiment of a cam follower according to the present invention.

FIG. 3 shows another exemplary embodiment of a cam follower according to the present invention.

### DETAILED DESCRIPTION

The present invention may be further understood with reference to the following description and the appended drawings, wherein like elements are referred to with the same reference numerals. Exemplary embodiments of the present invention describe cam followers in camming arrangements. It should be understood that the present invention may be implemented in any camming arrangement that utilizes a cam follower. Specifically, the exemplary embodiments are described with reference to a cam follower contacting a cam. The cam follower of the present invention may also be used in rail applications, i.e., where the cam follower is contacting a rail system, such as in a conveyor system. Moreover, the cam follower of the present invention is suitable for any application where a cam follower is used, subject to the environmental capabilities of the material being used.

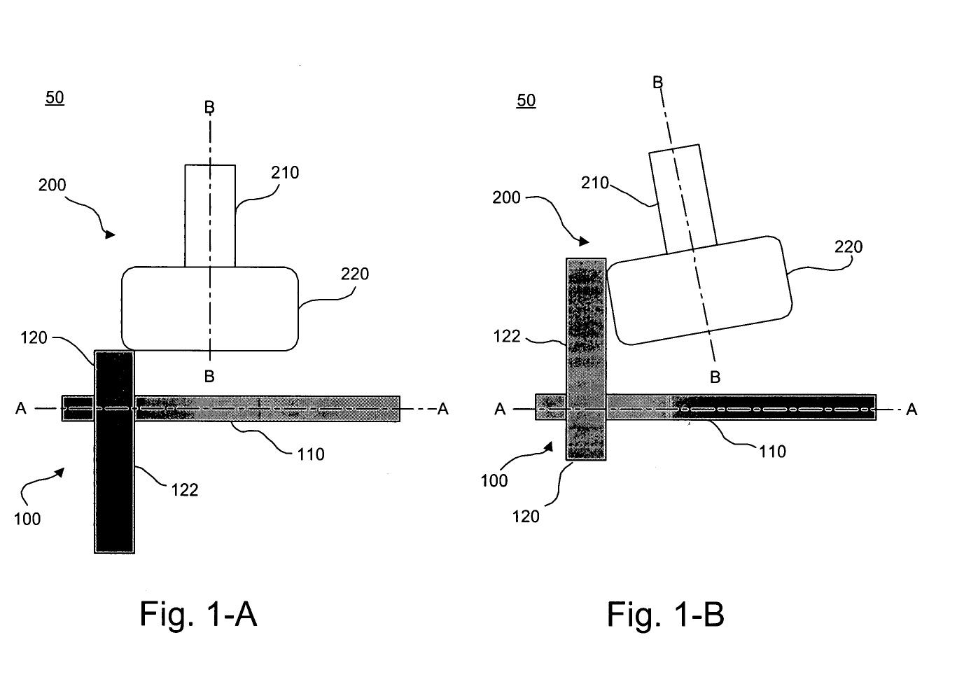

FIG. 1-A shows an exemplary embodiment of a camming arrangement 50, which includes a cam 100 and a cam follower 200. The camming arrangement 50 may be components in a packaging machine, a canning machine, etc. and translates an input motion into a reciprocating motion. For example, the cam 100 may be mounted on a cam shaft 110 that rotates about a first axis (indicated by line A-A). The rotation of the cam 100 about the first axis causes a head portion 220 of the cam follower 200 to rotate about a second axis (indicated by line B-B) in addition to imparting the reciprocating motion upon a follower shaft 210. As shown in FIG. 1-A, the camming arrangement 50 is in a neutral position in which a non-engaging portion 120 of the cam 100 faces the cam follower 200. The cam 100 is shaped and/or positioned so that rotating the cam shaft 110 causes an engaging portion 122 of the cam 100 to periodically contact and displace the cam follower 200.

FIG. 1-B shows an exemplary embodiment of the camming arrangement 50 in an engaged position. As shown, the engaging portion 122 has angularly displaced the cam follower 200 while simultaneously causing the head 220 to rotate about the second axis. Those of skill in the art will understand that other embodiments of the present invention may feature additional or alternative types of motion (e.g., lateral/longitudinal displacement, axial rotation, etc.) depending on a particular configuration of a camming arrangement.

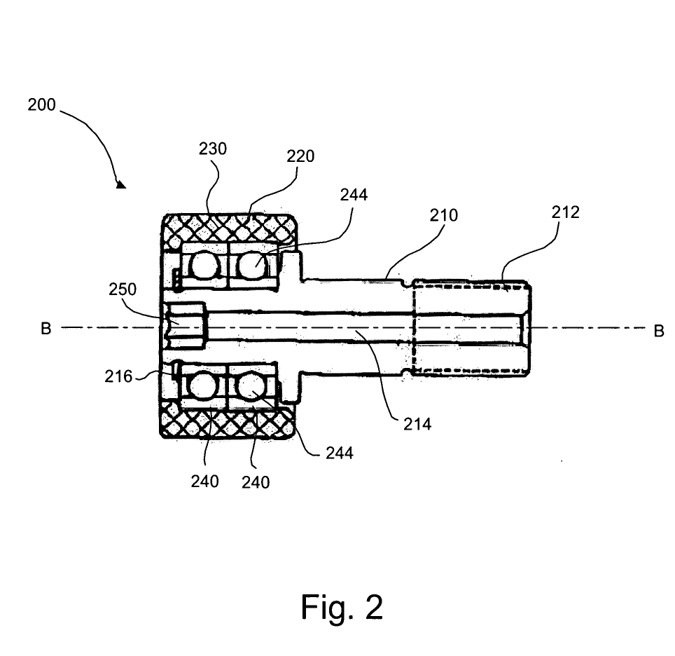

An exemplary embodiment of a self-lubricating cam follower according to the present invention will be described with reference to the cam follower 200. FIG. 2 shows a cross-sectional view of the cam follower 200 taken along the line B-B. The follower shaft 210 may be formed of a rigid metal such as steel, aluminum, titanium, etc. The follower shaft 210 may include a threaded portion 212 that enables the cam follower 200 to be attached to a receiving arrangement of a machine component. An opposing end of the follower shaft 210 may include a groove for receiving a snap ring, which secures the follower shaft 210 to the head 220. A substantial portion 214 of the follower shaft 210 may be hollowed to accept the receiving arrangement therewithin. An opposing end of the follower shaft may include a hexagonal opening 250. The hexagonal opening may be used to engage an Allan type (hex) wrench to install the cam follower, e.g., turn the cam follower and install the threaded portion in the same manner as installing a bolt. Those skilled in the art will understand that the hexagonal opening may also be formed on the side of the cam follower that includes the threaded portion 212.

In the exemplary embodiment, the threaded portion 212 comprises a series of threaded grooves machined around an outer surface of the follower shaft 210. However, in other embodiments, the threaded grooves may be located around an inner surface of the follower shaft 210. It should also be understood that other attachment mechanisms may be utilized. For example, other embodiments may include snap-fitting, magnets, adhesives, clips and other attachment methods. In yet further embodiments, the follower shaft may be permanently attached using methods such as welding, bonding, etc.

The head 220 includes an outer racer 230 formed of a self-lubricating material such as Intech Corp's Power-Core™. The self-lubricating material is preferably low-friction (e.g., a coefficient of friction of 0.3) with a smooth outer texture and may be non-conductive (e.g., a dielectric constant of 3.2). The self-lubricating material is softer than the engaging portion 120 of the cam 100 (or rail). Thus, the exemplary cam follower 200 does not promote wear of the cam 100 as a result of repeated contact with the head 220. Therefore, since the cam 100 does not wear, replacement of the cam 100 is not required during periodic maintenance, thereby reducing the cost of maintenance and the down-time associated with maintenance.

In addition, the self-lubricating material is preferably heat tolerant and/or capable of operation under a broad range of ambient temperatures (e.g., −40 F to +140 F). Those skilled in the art will understand that rotation and friction generated heat can cause materials to wear faster than intended. Thus, conventional materials such as rubber are unsuited for use with the outer racer 230. The self-lubricating material also provides an increased shock and vibration tolerance over traditional metal cam follower material.

A hardness of the self-lubricating material may be selected based on desired operating characteristics. For example, a specific durometer rating of the self-lubricating material may be chosen as a function of shock-absorbing and/or wearing characteristics. The hardness may also be selected to enable the self-lubricating material to resist flattening when subjected to a load. The racer 220 is substantially cylindrical and a thickness thereof may also be selected based on the desired operating characteristics. For example, longer lifetimes may require a greater thickness. Thus, the racer 220 may be customized according to the needs of a particular application of the camming arrangement 50.

One or more bearings 240 may comprise an inner portion of the head 220. The exemplary embodiment shows a double bearing arrangement. However, a single bearing arrangement or other number of bearings may also be used. The exemplary embodiment also shows the bearings 240 as roller bearings. The bearings 240 are concentric with the outer racer 230 and rotate about a central axis (e.g., the second axis) of the follower shaft 210. Each bearing 240 includes one or more cylindrical rollers 244, which may be formed of a smooth metal coated with the self-lubricating material. The rollers 244 may be lubricated for a life of the cam follower 200 and maintenance-free. In a typical arrangement, the rollers 244 are pre-lubricated with grease by the bearing manufacturer as part of the manufacturing process. A special grease may be used for clean room or food applications. However, in this pre-lubrication example, the manufacturer will normally have a precise application of grease and seal the rollers so that there is little chance of grease being expelled from the rollers. In other embodiments, other types of bearings (e.g., ball bearings, needle bearings, etc.) may be used. However, those skilled in the art will understand that roller bearings are generally capable of higher rotational speeds and require less force to start and sustain motion compared to needle bearings used in conventional cam followers. In addition, roller bearings generally have a higher axial load capacity. Thus, the rollers 244 in conjunction with the self-lubricating material, enable the head 220 to rotate quietly (e.g., 6 to 10 dB) at high speeds. This quiet operation may be valuable in meeting industrial safety regulations such as OSHA regulations.

Because internal and external lubrication are not utilized, the cam follower 200 is not susceptible to problems associated with lubricated cam followers. Those skilled in the art will understand that conventional lubricants (e.g., grease, oil, etc.) can clog components over time (e.g., viscosity breakdown, attracting foreign particles, etc.), be transferred unintentionally (e.g., leakage) to other machine components, or contaminate products produced on the machines. In addition, over-lubricating can increase internal friction, causing a cam follower to stop rotating and develop a flat as a result of repeated contact with a cam. The cam follower 200 overcomes these problems and provides consistent and predictable performance. Consequently, an estimated lifetime of the cam follower 200 may be accurately calculated based on material properties and/or geometries of the bearings 240 and the outer racer 230. Physical properties such as maximum load capacity and deformation (e.g., flattening of the outer racer 230) under static or dynamic loads may also be determined.

In addition, the exemplary cam follower of the present invention will be lighter than a standard cam follower because the self-lubricating material will be lighter than a metal cam follower and it will include no lubrication (e.g., grease) which also adds weight to the cam follower. A lighter cam follower has less inertia and is particularly adaptable for high speed applications. For example, a typical machine performing necking operations for canning may have 2400 reciprocations per minute. In many industries, manufacturers are attempting to increase speed so that production can be more efficient. Another exemplary application may be in sewing machines. Faster operations of the sewing machine will lead to a decrease in the production cost of clothing, making the manufacturer more competitive. In addition, the low inertia of the exemplary embodiment of the cam follower may also have applications for reversing operations, i.e., the machine may be able to reverse easier because of the low inertia of the cam followers.

An exemplary embodiment of a method for assembling the cam follower 200 will now be described. The outer racer 230 may be precision machined from a standard sized cylinder of the self-lubricating material. The outer racer 230 is cut with a specific undersize and placed in a curing oven that is preheated to a temperature (e.g., 250□ F to 300□ F) suited to the size of the outer racer 230. The undersize of the outer racer is determined such that the inside diameter of the outer race 230 is less than the outside diameter of the bearings 240. The undersize, the oven temperature and a duration in which the outer racer 230 remains in the oven is calculated as a function of geometric and material parameters such as, for example, a wall thickness, a coefficient of linear expansion, a resulting pressure of the outer racer 230 on the bearings 240 when cooled, etc.

After becoming plasticized, the outer racer 230 is removed from the oven and may be allowed to partially cool. The bearings 240 are then inserted through a chamfered end of the outer racer 230. After the outer racer 230 is fully cooled, a compressive force is created by contraction of the self-lubricating material. The bearings 240 are held securely in place by this compressive force. The follower shaft 210 is inserted through the chamfered end and secured using the snap ring 216. Being fully assembled, the cam follower 200 may then be attached to the receiving arrangement.

As the cam follower 200 continues to contact the cam 100 during normal operations, the outer racer 230 is gradually worn down. Because the self-lubricating surface of outer racer 230 provides consistent contact, wearing is even about the entire circumference of the outer racer 230, which slowly decreases in diameter. Eventually, the outer racer 230 is reduced to a size that is unacceptable for performance and/or safety reasons. For example, the size reduction may affect a timing of machine components or even cause the cam 100 to fail to properly engage the cam follower 200. At this time, maintenance personnel may choose to replace the cam follower 200.

Replacement may involve detaching the cam follower 200, removing the outer racer 230 and installing a new outer racer. If the bearings 240 are worn, they may also be replaced by removing the snap ring 216, detaching the head 220 from the follower shaft 210 and sliding the bearings 240 out so that new bearings may be inserted. Alternatively, the wearing may be extensive or the maintenance personnel may decide that disassembling the cam follower 200 would be too difficult/time-consuming. In such an instance, the entire cam follower 200 may be replaced with a new cam follower. However, as noted above, only the cam follower 200 needs to be replaced and not the cam 100 itself. In addition, the time consuming and potentially detrimental effects of adding lubricant to the cam follower 200 and/or the cam 100 are no longer needed.

The following provides two exemplary application parameters for the cam follower of the present invention. In the first exemplary embodiment, the cam (or rail) follower has an outside diameter (“OD”) of 32 mm (e.g., the OD of the outer racer 230). The linear speed of the application is 5.1 m/sec and a maximum impact load of 849 lbf during one cycle. The cycle time is 0.15 seconds with an operation time of 24 hours/day. In a second exemplary embodiment, the OD is 28 mm, the linear speed is 5.1 m/sec with a maximum impact load of 76 lbf during one cycle. The cycle time is 0.15 seconds with an operation time of 24 hours/day. Those skilled in the art will understand that the cam (rail) follower of the present invention is not limited to the above parameters, but are merely used to show examples of operating conditions in which the present invention may be used.

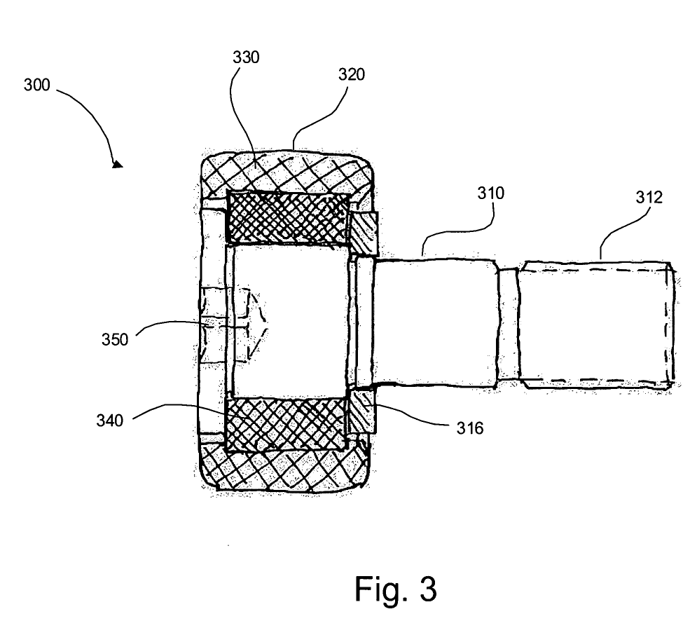

FIG. 3 shows a cross-sectional view of an exemplary embodiment of a cam follower 300, which may include components substantially similar to those of the cam follower 200. For example, the cam follower 300 may include a follower shaft 310 with a threaded portion 312 and a hexagonal opening 350. The follower shaft 310 maybe secured to a head 320 using a metal washer or snap ring 316 and may include an outer racer 330 formed of the self-lubricating material. The cam follower 300 also includes an inner bushing 340, which is concentric with the outer racer 330 and rotates about a central axis of the follower shaft 310. The inner bushing 340 may be formed of a high pressure velocity (“PV”) value polymer (e.g., polyimidamid, etc.). The bushing 340 will allow the cam follower 300 be lighter than the cam follower described above because the bushing 340 will be lighter than the roller bearings. This means that the cam follower 300 is capable of higher rotational speeds compared to the cam follower with the bearings. The cam follower 300 may be capable of a rotational speed in excess of 30,000 rpm.

The bushing 340 may also provides enhanced shock/vibration absorption. In addition, the bushing 340 has a longer wear life than the bearings 240 and may even outlast the outer racer 330 because it may stand frictional heat up to 600 F. However, the bushing 340 is non-lubricated and because it is not formed of metal, reduces an axial load capacity of the cam follower 300. Thus, this exemplary embodiment may be more suitable to low load/high speed applications.

The above exemplary embodiments have been described with reference to a complete cam follower. For example, the first embodiment describes a cam follower 200 having a shaft portion 200 and a head portion 220. The head portion 220 includes an outer racer 230 and bearings 240. Those skilled in the art will understand that the head portion 220 may also be referred to as a yoke. The yoke (e.g., the outer racer 230 and the bearings 240, the outer racer 330 and bushing 340) may be supplied separate from the shaft portion. That is, the yoke may be supplied and attached to a shaft that is currently attached to a machine. Thus, currently operating machines may be retrofitted using the exemplary embodiment of the present invention without providing new shafts.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A follower, comprising:
a shaft;
a rotational inner portion rotating about the shaft;
an outer racer rotating about the shaft, the outer racer being constructed from a self-lubricating material.

2. The follower of claim 1, wherein the follower is one of a cam follower and a rail follower.

3. The follower of claim 1, wherein the rotational inner portion is a roller bearing.

4. The follower of claim 1, wherein the rotational inner portion is an engineered polymer bushing.

5. The follower of claim 1, wherein the outer racer is shrink fit onto the rotational inner portion.

6. The follower of claim 1, wherein the self-lubricating material of the outer racer is softer than a surface with which the follower is contacting.

7. The follower of claim 1, wherein the shaft includes a threaded portion for attaching the follower to a further arrangement.

8. The follower of claim 1, further comprising:
a snap ring to hold the rotational inner portion and the outer racer to the shaft.

9. The follower of claim 1, further comprising:
a press washer to hold the rotational inner portion and the outer racer to the shaft.

10. A system, comprising:
a cam follower including a shaft and an outer racer, the outer racer being constructed from a self-lubricating material; and
a cam, the outer racer of the cam follower being in contact with the cam, the contact causing the outer racer to rotate about the shaft of the cam follower, the self lubricating material being softer than a material used to construct the cam.

11. The system of claim 10, wherein the cam follower further includes a rotational inner portion.

12. The system of claim 11, wherein the rotational inner portion is a roller bearing.

13. The system of claim 11, wherein the rotational inner portion is an engineered polymer bushing.

14. The system of claim 10, wherein the cam is one of a circular cam and a rail cam.

15. The system of claim 10, wherein the system is included as a portion of a machine.

16. The system of claim 15, wherein the machine is one of a canning machine, a dispensing machine, a packaging machine, an x-ray machine and a conveyor machine.

17. A cam follower, comprising:
a shaft;
at least one roller bearing rotatably coupled to the shaft; and
an outer racer coupled to the at least one roller bearing and being rotatable about the shaft, an outer surface of the outer racer being constructed from a self-lubricating material.

18. The cam follower of claim 17, wherein the outer racer is shrink fit coupled to the at least one roller bearing.

19. The cam follower of claim 17, wherein the at least one roller bearing is two roller bearings.

20. A yoke assembly, comprising:
a rotational inner portion for rotating about a shaft;
an outer racer coupled to the rotational inner portion, the outer racer being constructed from a self-lubricating material.
